(19) United States
(12) Patent Application Publication
(10) Pub. No.: US 2019/0012767 A1
(43) Pub. Date: Jan. 10, 2019

(54) TERMINAL DEVICE, DISPLAY SYSTEM, AND CONTROL METHOD OF TERMINAL DEVICE

(71) Applicant: SEIKO EPSON CORPORATION, Tokyo (JP)

(72) Inventor: Yoetsu IWATA, Sapporo-Shi (JP)

(73) Assignee: SEIKO EPSON CORPORATION, Tokyo (JP)

(21) Appl. No.: 16/019,697

(22) Filed: Jun. 27, 2018

(30) Foreign Application Priority Data
Jul. 5, 2017 (JP) 2017-131934

(51) Int. Cl. G06T 3/40

(52) U.S. Cl. CPC G06T 3/40; G06T 2200/24

(57) ABSTRACT

A terminal device that communicates with a display device includes: an obtaining unit that obtains image data including a first image and a second image from the display device; a determination unit that determines whether or not the length of one side of a display area included in the terminal device is equal to or longer than a predetermined length; and a display control unit that causes, when a result of determination of the determination unit is positive, both the first image and the second image to be displayed in the display area, and causes, when the result of determination is negative, the first image to be displayed in the display area without causing the second image to be displayed.

### CROSS-REFERENCE

The entire disclosure of Japanese Patent Application No. 2017-131934, filed Jul. 5, 2017 is expressly incorporated by reference herein.

### BACKGROUND

### 1. Technical Field

The present invention relates to a terminal device, a display system, and a control method of a terminal device.

### 2. Related Art

A display system in which the settings of a display device are adjusted through a terminal device connected to the display device has been known. For example in a display system disclosed in JP-A-2006-301432, a control computer serving as a terminal device obtains an operation page for adjusting the settings of a projector serving as a display device from the projector, and displays the operation page in a display area (e.g., a monitor) of the control computer. A user can adjust the settings of the projector by operating the operation page displayed in the display area of the control computer.

Incidentally, a plurality of setting pages such as a menu page and an adjustment page may be included in the operation page. On the other hand, depending on the size of the display area included in the terminal device, it may be impossible to display all of the plurality of setting pages included in the operation page in a size that is easy for the user to operate. In such a case, when the terminal device displays the plurality of setting pages in the display area, an area where each page is displayed is narrowed, and thus it may be difficult for the user to operate the setting page.

### SUMMARY

An advantage of some aspects of the invention is to improve the operability of a terminal device when a setting page of a display device is displayed on the terminal device.

A terminal device according to an aspect of the invention is a terminal device that communicates with a display device. The terminal device includes: an obtaining unit that obtains image data including a first image and a second image from the display device; a determination unit that determines whether or not the length of one side of a display area included in the terminal device is equal to or longer than a predetermined length; and a display control unit that causes, when a result of determination of the determination unit is positive, both the first image and the second image to be displayed in the display area, and causes, when the result of determination is negative, the first image to be displayed in the display area without causing the second image to be displayed.

According to the terminal device described above, when the length of the one side of the display area of the terminal device is less than the predetermined length, the first image out of the first image and the second image is displayed in the display area. For this reason, compared to the case where both the first image and the second image are caused to be displayed in the display area, an area where the first image is displayed is widened, and thus a reduction in the visibility of the first image is suppressed. As a result, the operability of the terminal device is improved, compared to the case where both the first image and the second image are displayed in the display area irrespective of whether or not the length of the one side of the display area of the terminal device is equal to or longer than the predetermined length.

The terminal device described above may further include: an attitude detecting unit that detects the attitude of the display area; and a selection unit that selects, according to a result of detection of the attitude detecting unit, the one side from a plurality of sides included in the display area.

According to the aspect with this configuration, the one side of the display area is selected according to the attitude of the display area of the terminal device. That is, the second image is switched between display and non-display according to the attitude of the display area. For this reason, compared to a configuration in which the first image and the second image are always displayed in the display area even when the attitude of the display area of the terminal device is changed, a reduction in the visibility of the first image when the length of the one side of the display area is less than the predetermined length is suppressed, and thus the operability of the terminal device can be improved.

The terminal device described above may further include an input detecting unit that detects an operation, the image data may further include a third image, and the display control unit may cause, when the result of determination is negative, the first image and the third image to be displayed in the display area, and may further cause, when the input detecting unit detects an operation of designating the third image displayed in the display area, the second image to be displayed in the display area.

According to the aspect with this configuration, the second image is displayed according to the needs of the user, and therefore, the operability of the terminal device is further improved.

The invention can also be understood as a display system including: a display device; and a terminal device that communicates with the display device, wherein the display device includes a transmission unit that transmits image data including a first image and a second image, and the terminal device includes an obtaining unit that obtains the image data transmitted by the transmission unit, a determination unit that determines whether or not the length of one side of a display area included in the terminal device is equal to or greater than a predetermined threshold, and a display control unit that causes, when a result of determination of the determination unit is positive, both the first image and the second image to be displayed in the display area, and causes, when the result of determination is negative, the first image to be displayed in the display area without causing the second image to be displayed.

According to this aspect, a reduction in the visibility of the first image on the terminal device when the length of the one side of the display area is less than the predetermined threshold is suppressed, and as a result, the operability of the terminal device is improved.

Moreover, the invention can also be understood as a control method of the terminal device described above. Also in this aspect, advantageous effects similar to those of the terminal device described above are provided.

### BRIEF DESCRIPTION OF THE DRAWINGS

The invention will be described with reference to the accompanying drawings, wherein like numbers reference like elements.

FIG. 1 is a diagram showing a configuration example of a display system according to an embodiment.

FIG. 2 is a flowchart for explaining a process of a terminal device according to the embodiment.

FIG. 3 is a diagram showing a display example of an operation page displayed on the terminal device.

FIG. 4 is a diagram showing a display example of the operation page displayed on the terminal device.

FIG. 5 is a flowchart for explaining a process of the terminal device according to a modified example.

FIG. 6 is a diagram showing a display example of the operation page displayed on the terminal device.

FIG. 7 is a diagram showing a display example of the operation page displayed on the terminal device.

FIG. 8 is a diagram showing a display example of the operation page displayed on the terminal device.

### DESCRIPTION OF EXEMPLARY EMBODIMENTS

Hereinafter, an embodiment of the invention will be described with reference to the drawings. In the drawings, however, the dimensions and scales of each part are appropriately different from actual dimensions and scales. The embodiment described below is a preferred specific example of the invention, and various technically preferable limitations are imposed on the embodiment. However, the scope of the invention is not limited to the embodiment unless a particular description that limits the invention is mentioned in the following description.

### 1. Embodiment

### 1.1. Configuration of Display System

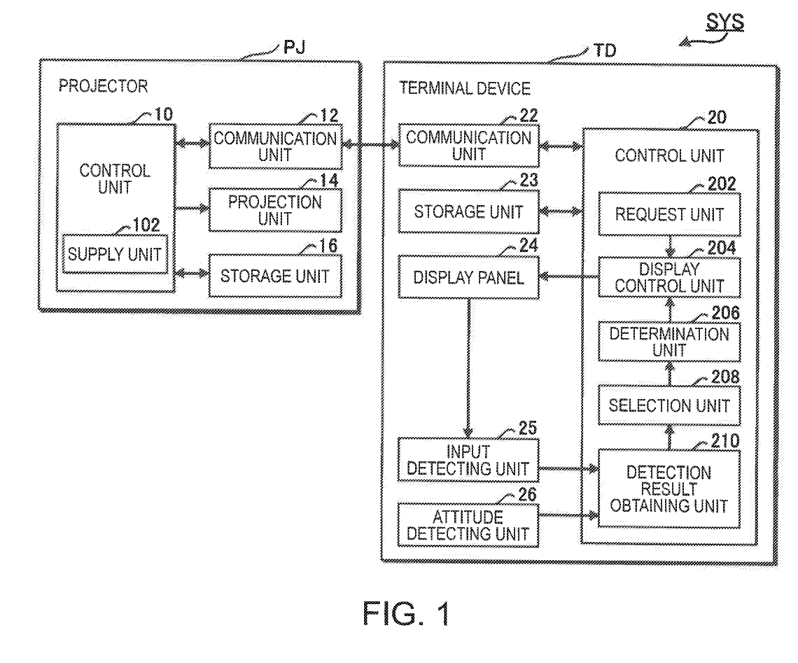

With reference to FIG. 1, a configuration example of a display system SYS according to an embodiment of the invention will be described. FIG. 1 is a block diagram showing the configuration example of the display system SYS. The display system SYS includes a projector PJ (an example of “display device”) and a terminal device TD communicating with the projector PJ. The projector PJ and the terminal device TD communicate with each other through, for example, a network (not shown) such as a mobile communication network, a wide area network (WAN) such as the Internet, or a local area network (LAN). In the embodiment, it is assumed that the projector PJ and the terminal device TD communicate with each other in conformity with a hypertext transfer protocol (HTTP); however, other communication protocol such as, for example, a near field communication (NFC) standard may be used. Moreover, in the embodiment, the case where the projector PJ and the terminal device TD wirelessly communicate will be illustrated and described; however, the projector PJ and the terminal device TD may communicate through a wire. The terminal device TD is, for example, an information processing terminal such as a smartphone, a feature phone, a tablet terminal, or a personal computer. In the embodiment, the case where the terminal device TD is a smartphone will be illustrated and described.

The projector PJ includes a communication unit 12 (an example of “transmission unit”) for communicating with the terminal device TD, a projection unit 14 that projects an image according to an image signal supplied from a host device (not shown), a storage unit 16 that stores various data including the image signal and programs, and a control unit 10 that controls working of each element of the projector PJ.

The data stored in the storage unit 16 includes an adjustment page Ps (an example of “first image”) for adjusting the settings of the projector PJ, and a menu page Pm (an example of “second image”) showing an operation menu of the projector PJ. In the following, the adjustment page Ps and the menu page Pm may be collectively referred to as “setting page P”. The setting page P may be generated by the control unit 10 of the projector PJ, may be previously stored in the storage unit 16, or may be obtained by the projector PJ from an external device (e.g., a host device). In the embodiment, the setting page P is a graphical user interface (GUI) image described in a hypertext markup language (HTML).

The control unit 10 includes a supply unit 102 that supplies image data G to the terminal device TD according to a request signal R received from the terminal device TD and indicating a request of the terminal device TD. More specifically, when the supply unit 102 receives the request signal R requesting the setting page P (referred to as “setting page request signal Rp”) from the terminal device TD, the supply unit 102 generates the image data G based on the setting page P stored in the storage unit 16, and supplies the image data G to the terminal device TD through the communication unit 12. The image data G is data obtained by adding information such as, for example, an HTTP header to the setting page P in order for the communication unit 12 to transmit the setting page P to the terminal device TD. In the embodiment, the image data G includes the adjustment page Ps and the menu page Pm.

The control unit 10 and the supply unit 102 included in the control unit 10 are functional blocks that are realized when a not-shown central processing unit (CPU) in the projector PJ executes the program stored in the storage unit 16 and functions according to the program.

The terminal device TD includes a control unit 20 that controls working of each element of the terminal device TD, a communication unit 22 for communicating with the projector PJ, a storage unit 23 that stores various data, a display panel 24 (an example of “display area”), an input detecting unit 25 that detects an operation of the user on the display panel 24, and an attitude detecting unit 26 that detects the attitude of the terminal device TD. In the embodiment, it is assumed that the display panel 24 is fixed to the terminal device TD. That is, it can be said that the attitude detecting unit 26 detects the attitude of the display panel 24.

The various data stored by the storage unit 23 includes programs and the setting page P (in the embodiment, the adjustment page Ps and the menu page Pm) included in the image data G received from the projector PJ. Moreover, the programs stored by the storage unit 23 include an operation application AP that is an application program for operating the projector PJ from the terminal device TD.

The display panel 24 is, for example, a touch-panel type liquid crystal display, and displays an image according to the control of the control unit 20. The display panel 24 is not limited to a liquid crystal display, and may be a display such as, for example, an organic electro-luminescence (EL) display or an electrophoretic display (EPD). In the embodiment, the display panel 24 includes M×N pixels (M is a natural number of 2 or more, and N is a natural number satisfying the relation: 1≤N<M) and a touch sensor that detects a touch of a finger of the user on the display panel 24. It is assumed that the display panel 24 in the embodiment has a substantially rectangular shape, and that the length of one side of the display panel 24 is represented by the number of pixels. That is, the length of the long side of the display panel 24 is M, and the length of the short side is N.

The input detecting unit 25 detects, based on a result of detection by the touch sensor included in the display panel 24, an operation of the user on the display panel 24, and generates and outputs an operation signal Sp indicating the detected operation.

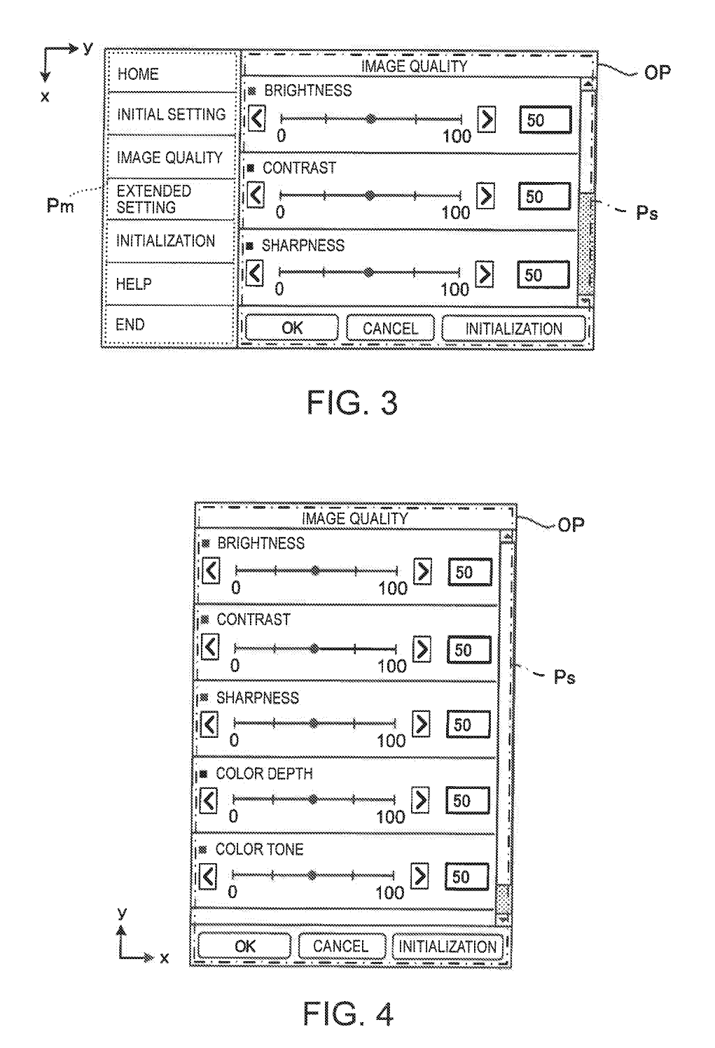

The attitude detecting unit 26 includes, for example, an acceleration sensor that detects gravitational acceleration, and generates, based on a result of detection by the acceleration sensor, an attitude signal St indicating the attitude of the terminal device TD. More specifically, the attitude detecting unit 26 calculates, based on a result of detection by the acceleration sensor, the relationship (e.g., an angle) between a gravitational acceleration direction (vertical direction) and a predetermined coordinate axis (e.g., see FIG. 3) included in a coordinate system fixed in the terminal device TD, and generates the attitude signal St based on a result of the calculation. In the embodiment, it is assumed that an x-axis parallel to the short side of the display panel 24 and a y-axis parallel to the long side of the display panel are fixed in the terminal device TD. Moreover, in the embodiment, the case where the attitude detecting unit 26 detects the attitude of the terminal device TD by calculating the angle between the vertical direction and the x-axis will be illustrated and described. For example, when the angle between the vertical direction and the x-axis falls within a predetermined range, the attitude detecting unit 26 detects that the terminal device TD is vertically oriented; and when the angle falls outside the predetermined range, the attitude detecting unit 26 detects that the terminal device is horizontally oriented. In the embodiment, it is assumed that the predetermined range is the range of 45 to 135 degrees and the range of 225 to 315 degrees. For example, when the angle between the x-axis and the vertical direction is 90 degrees, the attitude detecting unit 26 detects that the terminal device TD is vertically oriented; and when the angle between the x-axis and the vertical direction is 0 degrees (the x-axis and the vertical direction are parallel), the attitude detecting unit 26 detects that the terminal device is horizontally oriented. The attitude detecting unit 26 may detect the attitude of the terminal device TD by obtaining a display mode relating to the attitude of the terminal device TD and set by the user.

The control unit 20 of the terminal device TD includes a request unit 202 that requests the projector PJ to supply the image data G, a detection result obtaining unit 210 that obtains the operation signal Sp and the attitude signal St, a selection unit 208 that selects, according to the attitude signal St, one side from a plurality of sides included in the display panel 24, a determination unit 206 that determines whether or not the length of the one side of the display panel 24 selected by the selection unit 208 is equal to or greater than a threshold TH (an example of “predetermined length”), and a display control unit 204 that controls the display panel 24 according to a result of determination by the determination unit 206. The request unit 202 functions as an obtaining unit that obtains the image data G transmitted from the projector PJ according to a request.

In the embodiment, it is assumed that the selection unit 208 selects, according to the attitude of the terminal device TD, a side of the display panel 24 that indicates a horizontal width thereof. Specifically, when the terminal device TD is horizontally oriented, the selection unit 208 selects the long side of the display panel 24; and when the terminal device TD is vertically oriented, the selection unit 208 selects the short side of the display panel 24. Moreover, in the embodiment, the case where the threshold TH is a natural number satisfying the relation: N<TH≤M is illustrated and described. Hence, in the embodiment, when the terminal device TD is horizontally oriented, the result of determination of the determination unit 206 is positive; and when the terminal device TD is vertically oriented, the result of determination is negative.

The control unit 20 and each element included in the control unit 20 are functional blocks that are realized when a not-shown CPU in the terminal device TD executes the program stored in the storage unit 23 and functions according to the program. In particular, each element included in the control unit 20 shown in FIG. 1 is a functional block that is realized when the CPU executes the program including the operation application AP.

### 1.2. Working of Terminal Device

In the following, a GUI image displayed on the display panel 24 for operating the settings of the projector PJ from the terminal device TD is referred to as “operation page OP”. The operation page OP includes at least one setting page P.

When the user operates the operation page OP displayed on the display panel 24, the terminal device TD transmits the request signal R indicating a request according to the operation of the user to the projector PJ. More specifically, the input detecting unit 25 detects the operation of the user on the display panel 24, and supplies the operation signal Sp to the detection result obtaining unit 210. The control unit 20 of the terminal device generates, based on the operation signal Sp, the request signal R indicating a request designated by the user, and transmits the request signal R to the projector PJ through the communication unit 22. The control unit 10 of the projector PJ performs a process according to the request of the user based on the request signal R received from the terminal device TD through the communication unit 12.

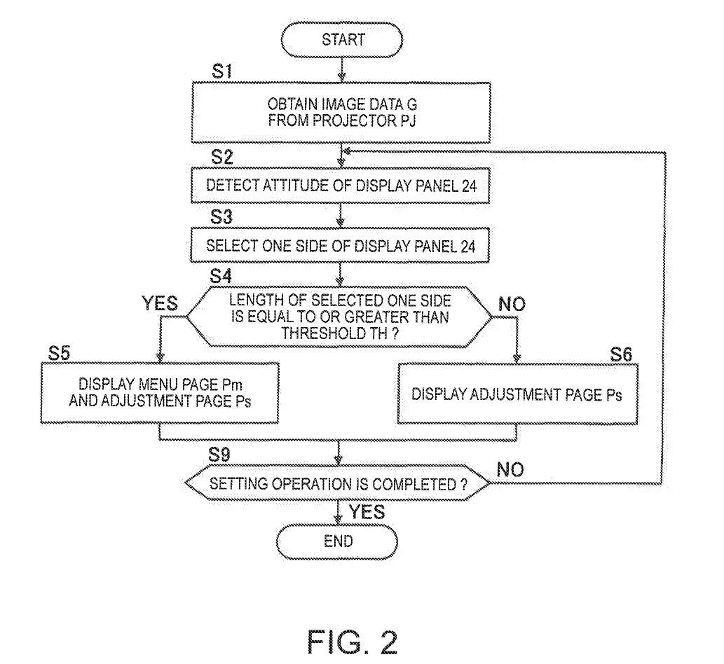

FIG. 2 is a flowchart for explaining an example of a process of the terminal device TD for causing the operation page OP to be displayed on the display panel 24 (hereinafter referred to as “operation page display process” in some cases).

In the flowchart shown in FIG. 2, it is assumed that the user operates the terminal device TD to request a setting operation to adjust the settings of the projector PJ. An operation of “requesting the setting operation of the projector PJ” is, for example, an operation of the user to launch the operation application AP.

The operation application AP may be launched through, for example, a general-purpose browser program. In this case, when the browser program is executed and a predetermined internet protocol (IP) address of the projector PJ is input in an address bar of the launched browser window, the control unit 20 may determine that the user requests the setting operation of the projector PJ, and launch the operation application AP.

When the user performs the operation of requesting the setting operation of the projector PJ, the request unit 202 generates the setting page request signal Rp, transmits the setting page request signal Rp to the projector PJ, and obtains the image data G including the adjustment page Ps and the menu page Pm (S1). The detection result obtaining unit 210 obtains the attitude signal St from the attitude detecting unit 26 (S2), and supplies the attitude signal St to the selection unit 208. The selection unit 208 selects one side of the display panel 24 based on the attitude signal St (S3), and supplies a signal indicating the selected one side to the determination unit 206.

The determination unit 206 determines, based on the signal supplied from the selection unit 208, whether or not the length of the selected one side is equal to or greater than the predetermined threshold TH (S4). If a result of determination is positive (YES in S4), the display control unit 204 causes both the adjustment page Ps and the menu page Pm included in the image data G to be displayed on the display panel 24 (S5). In the embodiment as described above, when the terminal device TD is horizontally oriented, the result of determination by the determination unit 206 is positive. FIG. 3 shows a display example of the operation page OP when the terminal device TD is horizontally oriented. As illustrated in FIG. 3, when the terminal device TD is horizontally oriented, the adjustment page Ps and the menu page Pm are included in the operation page OP displayed on the display panel 24. FIG. 3 illustrates the case where the display control unit 204 causes the adjustment page Ps and the menu page Pm to be displayed side by side in the y-direction. FIG. 3 shows an example in which the adjustment page Ps is displayed to the right (+y side) of the menu page Pm; however, the adjustment page Ps may be displayed to the left (−y side) of the menu page Pm.

On the adjustment page Ps illustrated in FIG. 3, adjustment items relating to the image quality of an image projected by the projector PJ are displayed. Specifically, in FIG. 3, “brightness”, “contrast”, and “sharpness” are shown as examples of the adjustment items included in the adjustment page Ps. The user can adjust the setting values concerning the adjustment items relating to the image quality by operating the adjustment page Ps as shown in FIG. 3. Moreover, the operation menu of the projector PJ is displayed on the menu page Pm illustrated in FIG. 3. Specifically, in FIG. 3, for example “initial setting”, “image quality”, “extended setting” and the like are shown as examples of operation items included in the operation menu. The user can select any operation item by operating the menu page Pm as shown in FIG. 3.

If the result of determination by the determination unit 206 is negative (NO in S4), the display control unit 204 causes the adjustment page Ps to be displayed on the display panel 24 while not causing the menu page Pm to be displayed (S6). In the embodiment as described above, when the terminal device TD is vertically oriented, the result of determination by the determination unit 206 is negative. FIG. 4 shows a display example of the operation page OP when the terminal device TD is vertically oriented. As shown in FIG. 4, when the terminal device TD is vertically oriented, the adjustment page Ps is included, but the menu page Pm is not included, in the operation page OP displayed on the display panel 24.

The adjustment items included in the adjustment page Ps shown in FIGS. 3 and 4, and the setting items included in the menu page Pm shown in FIG. 3, are illustrative. The adjustment page Ps may include other adjustment items instead of, or in addition to, the adjustment items illustrated in FIGS. 3 and 4. The menu page Pm may include other setting items instead of, or in addition to, the setting items illustrated in FIG. 3.

After Step S5 or S6 described above, the control unit 20 determines whether or not the user performs an operation of designating the completion of the setting operation (S9). The “operation of designating the completion of the setting operation” may be, for example, an operation of the user to end the operation application AP, or may be an operation of the user to select the item of “end” on the menu page Pm. If the user performs the operation of designating the completion of setting (YES in S9), the control unit 20 ends the operation page display process. If the result of determination in Step S9 is negative (NO in S9), the control unit 20 proceeds the process to Step S2, and periodically executes the processes of Steps S2 to S4, Step S5 or S6, and Step S9. With this configuration, even when the attitude of the display panel 24 is changed after Step S5 or S6, the operation page OP according to the attitude of the display panel 24 is displayed on the display panel 24 until the user performs the operation of designating the completion of setting. The control unit 20 may execute the processes of Steps S3 and S4, Step S5 or S6, and Step S9 only when the attitude of the display panel 24 is changed from the vertical orientation to the horizontal orientation, or when the attitude is changed from the horizontal orientation to the vertical orientation, based on the attitude signal St obtained by the detection result obtaining unit 210.

As described above, according to the embodiment, when the horizontal width of the display panel 24 is smaller than the threshold TH (e.g., when the terminal device TD is vertically oriented as shown in FIG. 4), the adjustment page Ps is displayed on the display panel 24 while the menu page Pm is not displayed thereon. For this reason, an area where the adjustment page Ps is displayed is widened, compared to the form (hereinafter referred to as “comparative example”) in which, even when the horizontal width of the display panel 24 is smaller than the threshold TH, both the menu page Pm and the adjustment page Ps are displayed on the display panel 24. Hence, according to the embodiment, compared to the comparative example, a reduction in the visibility of the adjustment page Ps when the horizontal width of the display panel 24 is smaller than the threshold TH is suppressed, and as a result, the operability of the terminal device TD is improved. Moreover, in the case where the display panel 24 is of a touch-panel type as illustrated in the embodiment, when the area where the adjustment page Ps is displayed is narrow, an event in which the user touches an unintended location on the display panel 24 and thus performs an erroneous operation is conceivably increased, compared to the case where the area where the adjustment page Ps is displayed is wide. For this reason, in the embodiment in which the display panel 24 of a touch-panel type is used, especially when the horizontal width of the display panel 24 is smaller than the threshold TH, the effect of improving the operability of the terminal device TD due to the widening of the area where the adjustment page Ps is displayed becomes remarkable.

Moreover, according to the embodiment, whether or not the menu page Pm is displayed on the display panel 24 is switched according to the attitude of the terminal device TD (i.e., the attitude of the display panel 24). For this reason, for example when the user changes the attitude of the terminal device TD from the horizontal orientation to the vertical orientation, the menu page Pm is automatically set to non-display, and thus a reduction in the visibility of the adjustment page Ps is suppressed.

### 2. Modified Examples

The above embodiment can be variously modified. Specific modification forms will be illustrated below. Any two or more forms selected from the following illustrated forms can be appropriately combined within a range in which the forms do not conflict with each other. In the modified examples illustrated below, elements whose operational effects or functions are equivalent to those of the embodiment are denoted by the reference numerals and signs referred to in the above description, and a detailed description of each element is appropriately omitted.

### 2.1. Modified Example 1

In the embodiment described above, the case where the adjustment page Ps and the menu page Pm are included in the image data G has been illustrated and described. However, the image data G may include, in addition to the adjustment page Ps and the menu page Pm, a menu button Pb (an example of “third image”) operated by the user for displaying the menu page Pm. The menu button Pb is, for example, a GUI image.

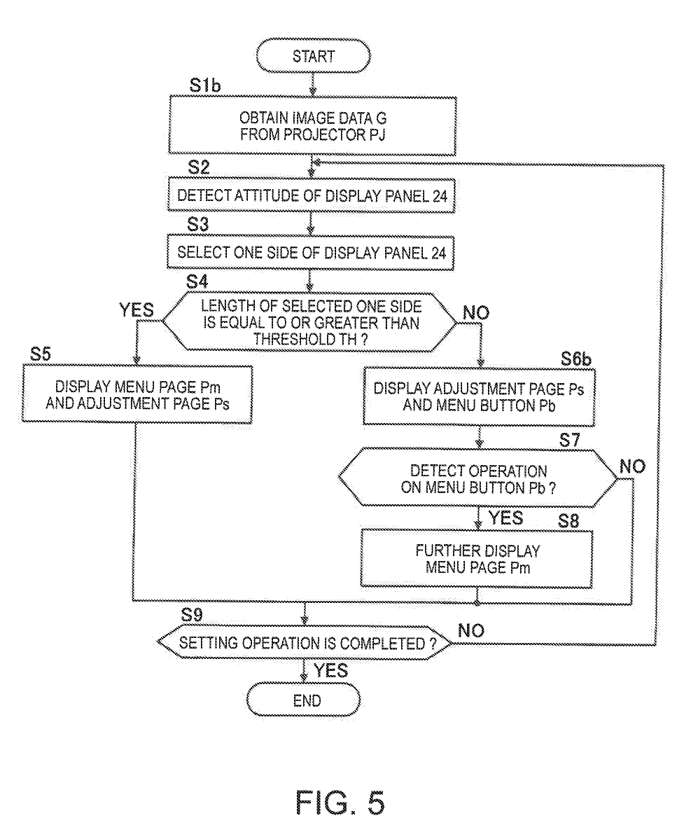

FIG. 5 is a flowchart for explaining an example of the operation page display process when the terminal device TD obtains the image data G including the menu button Pb from the projector PJ. In FIG. 5, the description of Steps in which processes similar to those of Steps described with reference to FIG. 2 are performed is appropriately omitted. The flowchart shown in FIG. 5 differs from the flowchart shown in FIG. 2 in that Step S1b is executed instead of Step S1 in FIG. 2, that Step S6b is executed instead of Step S6, and that Steps S7 and S8 are further executed.

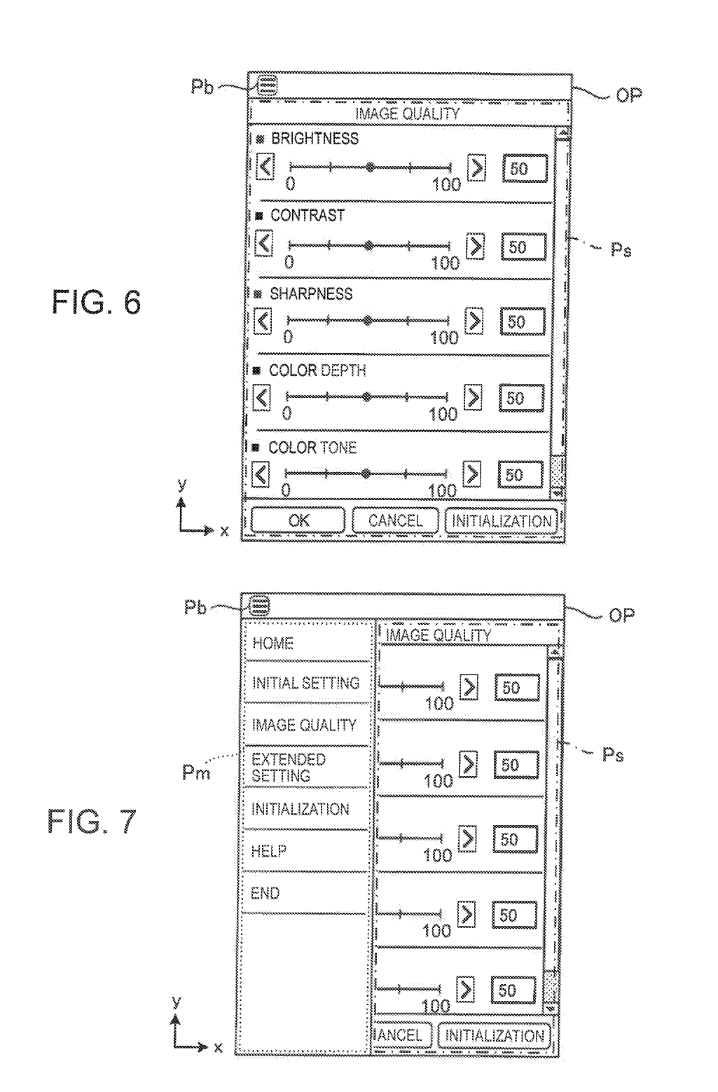

In Step S1b of FIG. 5, the request unit 202 obtains the image data G including the adjustment page Ps, the menu page Pm, and the menu button Pb from the projector PJ. Then, if the result of determination by the determination unit 206 is negative in Step S4 (NO in S4), the display control unit 204 causes the menu button Pb, in addition to the adjustment page Ps, to be displayed on the display panel 24 (S6b). FIG. 6 shows a display example of the operation page OP when the terminal device TD is vertically oriented (i.e., when the result of determination by the determination unit 206 is negative) in the modified example. FIG. 6 is similar to FIG. 4 in that the operation page OP includes the adjustment page Ps but does not include the menu page Pm, and differs from FIG. 4 in that the operation page OP further includes the menu button Pb. When the user performs an operation of designating the menu button Pb on the display panel 24, the input detecting unit 25 supplies the operation signal Sp indicating that the menu button Pb is designated to the detection result obtaining unit 210 (YES in S7). The operation of the user to designate the menu button Pb on the display panel 24 is, for example, an operation of tapping the menu button Pb on the display panel 24. When the operation signal Sp is supplied to the detection result obtaining unit 210, the display control unit 204 further causes the menu page Pm, in addition to the adjustment page Ps and the menu button Pb, to be displayed on the display panel (S8).

FIG. 7 shows a display example of the operation page OP when, in addition to the adjustment page Ps and the menu button Pb, the menu page Pm is displayed on the display panel 24 in Step S8. A display example of the operation page OP, when the result of determination in Step S4 is negative and the adjustment page Ps, the menu button Pb, and the menu page Pm are displayed on the display panel 24, is not limited to the example shown in FIG. 7. For example, the adjustment page Ps may be displayed in reduced size so as to fit in an area where the menu page Pm is not displayed.

If the operation signal Sp indicating that the menu button Pb is designated is not supplied to the detection result obtaining unit 210 in Step S7 of FIG. 5 (NO in S7), the display control unit 204 does not cause the menu page Pm to be displayed but causes the adjustment page Ps and the menu button Pb to be continuously displayed on the display panel 24 as shown in FIG. 6.

If the result of determination by the determination unit 206 is positive in Step S4 of FIG. 5 (YES in S4), the display control unit 204 causes the menu page Pm and the adjustment page Ps to be displayed on the display panel 24. In the case where the result of determination is positive in Step S4, the display control unit 204 may further cause the menu button Pb, in addition to the menu page Pm and the adjustment page Ps, to be displayed on the display panel 24. Moreover, in the state where the result of determination in Step S4 is positive and the menu page Pm is displayed, when the operation signal Sp indicating that the menu button Pb is designated is supplied to the detection result obtaining unit 210, the display control unit 204 may not cause the menu page Pm to be displayed. In other words, even when the terminal device TD is horizontally oriented (i.e., even when the horizontal width of the display panel 24 is equal to or greater than the threshold TH), if an operation on the menu button Pb is detected in the state where the menu page Pm, the adjustment page Ps, and the menu button Pb are displayed, the display control unit 204 may not cause the menu page Pm to be displayed on the display panel 24 but may cause the adjustment page Ps and the menu button Pb to be displayed thereon.

As will be understood from the above description, the display control unit 204 may switch the menu page Pm between display and non-display on the display panel 24 according to the presence or absence of the operation of designating the menu button Pb (more precisely, whether or not the operation signal Sp indicating that the menu button Pb is designated is supplied to the detection result obtaining unit 210).

According to the modified example, even when the menu page Pm is not displayed on the display panel 24, the user can switch the menu page Pm, as necessary, between display and non-display by operating the menu button Pb. Therefore, the operability of the terminal device TD is further improved.

### 2.2. Modified Example 2

In the embodiment and modified example described above, the case where the threshold TH is a natural number satisfying the relation: N<TH≤M has been illustrated and described. However, the value of the threshold TH is not limited to this example, and not limited to a fixed value. For example, the threshold TH may be dynamically defined based on the size (e.g., the number of pixels of the horizontal width) of at least one setting page P included in the image data G obtained from the projector PJ.

### 2.3. Modified Example 3

In the embodiment and modified examples described above, the case where the detection result obtaining unit 210 obtains the attitude signal St (S2 in FIG. 2 or 5), the selection unit 208 selects one side of the display panel 24 based on the attitude indicated by the attitude signal St (S3 in FIG. 2 or 5), and thereafter, the determination unit 206 determines whether or not the length of the selected side is equal to or greater than the threshold TH (S4 in FIG. 2 or 5) has been illustrated and described. However, the determination unit 206 may determine whether or not the length of a predetermined side is equal to or greater than the threshold TH. In this case, Steps S2 and S3 in FIG. 2 or 5 may be omitted, and the control unit 20 may not include the selection unit 208.

Instead of the above configuration, the display control unit 204 may cause the operation page OP to be displayed on the display panel 24 based on the attitude of the display panel 24. Specifically, when the detection result obtaining unit 210 obtains the attitude signal St indicating that the attitude of the display panel 24 is horizontally oriented, the display control unit 204 may perform the process of Step S5 in FIG. 2 or 5; and when the detection result obtaining unit 210 obtains the attitude signal St indicating that the attitude of the display panel 24 is vertically oriented, the display control unit 204 may perform the process of Step S6 in FIG. 2 or the process of Step S6b in FIG. 5. In this case, Steps S3 and S4 in FIG. 2 or 5 may be omitted, and the control unit 20 may not include the selection unit 208 and the determination unit 206.

### 2.4. Modified Example 4

In the embodiment and modified examples described above, the case where the selection unit 208 selects the side of the display panel 24 that indicates the horizontal width thereof has been illustrated and described. However, the selection unit 208 may select a side of the display panel 24 that indicates the height (vertical width) thereof. Specifically, the selection unit 208 may select the short side of the display panel 24 when the terminal device TD is horizontally oriented, and may select the long side of the display panel 24 when the terminal device TD is vertically oriented.

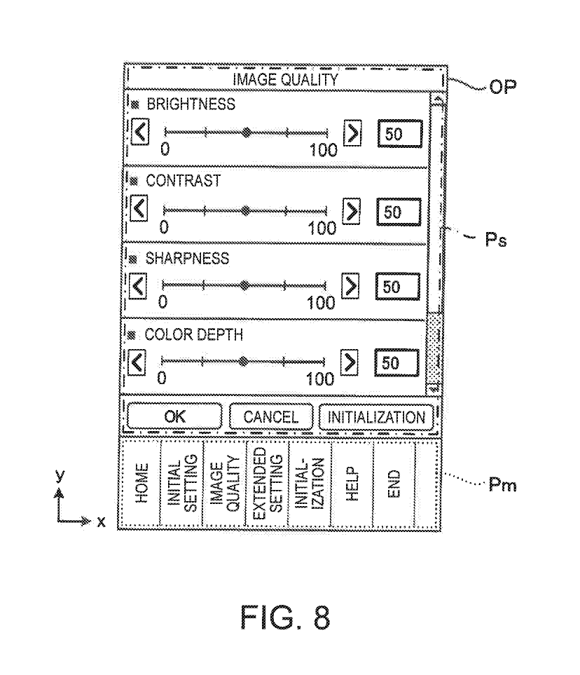

FIG. 8 shows a display example of the operation page OP according to the modified example when the operation page OP includes the adjustment page Ps and the menu page Pm. FIG. 8 shows an example in which the adjustment page Ps is displayed above (+y side) the menu page Pm; however, the adjustment page Ps may be displayed below (−y side) the menu page Pm.

Whether the selection unit 208 selects the side indicating the horizontal width of the display panel 24 or the side indicating the vertical width thereof may be previously determined, or the user may designate the side.

### 2.5. Modified Example 5

In the embodiment and modified examples described above, the projector PJ has been illustrated and described as the display device; however, the display device is not limited to a projection-type display device, but may be, for example, a direct-view-type display device such as a liquid crystal television.

As understood from the above description, the invention can be understood as a terminal device such as the terminal device TD, and also as a display system including a display device such as the projector PJ and a terminal device. Moreover, the invention can be understood as a control method of the terminal device TD for realizing processes carried out by the terminal device TD, or as a program executed by a processor (e.g., a CPU) of the terminal device TD for causing the terminal device TD to execute the processes. The program according to the invention may be provided in the form of a recording medium that stores the program, or may be provided by downloading the program into a processor of an information processing device through a network such as the Internet.

What is claimed is:

1. A terminal device that communicates with a display device, comprising:
an obtaining unit that obtains image data including a first image and a second image from the display device;
a determination unit that determines whether or not the length of one side of a display area included in the terminal device is equal to or longer than a predetermined length; and
a display control unit that causes, when a result of determination of the determination unit is positive, both the first image and the second image to be displayed in the display area, and causes, when the result of determination is negative, the first image to be displayed in the display area without causing the second image to be displayed.

2. The terminal device according to claim 1, further comprising:
an attitude detecting unit that detects the attitude of the display area; and
a selection unit that selects, according to a result of detection of the attitude detecting unit, the one side from a plurality of sides included in the display area.

3. The terminal device according to claim 1, further comprising an input detecting unit that detects an operation, wherein
the image data further includes a third image, and
the display control unit causes, when the result of determination is negative, the first image and the third image to be displayed in the display area, and further causes, when the input detecting unit detects an operation of designating the third image displayed in the display area, the second image to be displayed in the display area.

4. The terminal device according to claim 1,
wherein the first image is an adjustment page to adjust the setting values relating to the image quality.

5. The terminal device according to claim 1,
wherein the second image is a menu page to select operation item.

6. A display system comprising:
a display device; and
a terminal device that communicates with the display device, wherein
the display device includes a transmission unit that transmits image data including a first image and a second image, and
the terminal device includes
an obtaining unit that obtains the image data transmitted by the transmission unit,
a determination unit that determines whether or not the length of one side of a display area included in the terminal device is equal to or greater than a predetermined threshold, and
a display control unit that causes, when a result of determination of the determination unit is positive, both the first image and the second image to be displayed in the display area, and causes, when the result of determination is negative, the first image to be displayed in the display area without causing the second image to be displayed.

7. The display system according to claim 6,
wherein the terminal device includes
an attitude detecting unit that detects the attitude of the display area; and
a selection unit that selects, according to a result of detection of the attitude detecting unit, the one side from a plurality of sides included in the display area.

8. The display system according to claim 6,
wherein the terminal device includes an input detecting unit that detects an operation, wherein
the image data further includes a third image, and
the display control unit causes, when the result of determination is negative, the first image and the third image to be displayed in the display area, and further causes, when the input detecting unit detects an operation of designating the third image displayed in the display area, the second image to be displayed in the display area.

9. The display system according to claim 6,
wherein the first image is an adjustment page to adjust the setting values relating to the image quality.

10. The display system according to claim 6,
wherein the second image is a menu page to select operation item.

11. A control method of a terminal device that communicates with a display device, the control method comprising:
obtaining image data including a first image and a second image from the display device;
determining whether or not the length of one side of a display area included in the terminal device is equal to or longer than a predetermined length; and
causing, when a determination result is positive, both the first image and the second image to be displayed in the display area, and causing, when the determination result is negative, the first image to be displayed in the display area without causing the second image to be displayed.
